(19) United States
(12) Patent Application Publication
(10) Pub. No.: US 2009/0086212 A1
(43) Pub. Date: Apr. 2, 2009

(54) SEMICONDUCTOR RING LASER GYRO

(76) Inventor: Atsushi Kitamura, Kikugawa (JP)

Correspondence Address: BRINKS HOFER GILSON & LIONE, P.O. BOX 10395, CHICAGO, IL, 60610, US

(21) Appl. No.: 12/182,387

(22) Filed: Jul. 30, 2008

(30) Foreign Application Priority Data
Aug. 2, 2007 (JP) JP2007-201670

(51) Int. Cl. G01C 19/66

(52) U.S. Cl. 356/460

(57) ABSTRACT

A semiconductor ring laser gyro comprises: A semiconductor ring laser gyro comprises: a closed optical circuit, the closed optical circuit comprising a plurality of reflection members; a semiconductor laser element disposed in the closed optical circuit and emitting laser light from each end thereof, the semiconductor laser element having a luminous region with a width that is at least ten times as large as a wavelength of the laser light; and a pair of optical systems for forming a shape of the laser light emitted from each end of the semiconductor laser element.

In a semiconductor ring laser gyro having a ring resonation structure, a semiconductor laser element with a luminous region having a width which is ten times or more as large as an oscillation wavelength is used as an exciting source, or a semiconductor laser element with a luminous region having a aspect ration of 1 to 10 or more is used as an exciting source, whereby the optical characteristics required of a condenser lens are reduced, and the tolerance for the optical axis accuracy about reflection members is secured. Thus, a semiconductor ring laser gyro is provided which is inexpensively produced with a high productivity, and whose measurement accuracy is scarcely affected by disturbances and also is stably assured.

### REFERENCE TO THE RELATED APPLICATIONS

This application claims priority under 35 U.S.C. §119 to Japanese Patent Application No. JP2007-201670 filed on Aug. 2, 2007, the entire content of which is hereby incorporated by reference.

### BACKGROUND OF THE INVENTION

1. Field of the Invention

The present invention relates to a semiconductor ring laser gyro using a semiconductor laser as a light source, and particularly to a semiconductor ring laser gyro in which laser light generated by the semiconductor laser as a light source has a characteristic beam shape.

2. Description of the Related Arts

A gyroscope has been conventionally known as a means of measuring the rotational angular velocity of an object. Among others, a ring laser gyro, which utilizes the Sagnac effect, is adapted to precisely measure the rotational angular velocity and therefore is widely used, particularly in the aircraft and rocket industries. While an He—Ne gas laser is primarily used as s laser light source for the ring laser gyro described above, a semiconductor laser, which is advantageous in reduction of device size and power consumption, is recently used increasingly (for example, Japanese Patent Application Laid-Open No. 2001-50753, Japanese Patent Application Laid-Open No. 2003-139539, and Japanese Patent Application Laid-Open No. 2006-319104). The semiconductor ring laser gyro using a semiconductor laser as described above (hereinafter referred to as “semiconductor ring laser gyro”) is advantageous in reduction of size and weight and further in power consumption over a conventional gyro utilizing a rotating body. Also, the semiconductor ring laser gyro operates electronically and does not use mechanical components and therefore has an advantage over the conventional gyro in that cost can be reduced and reliability is enhanced.

FIG. 7 is a top plan view of an example of a conventional semiconductor laser ring gyro. The semiconductor ring laser gyro shown in FIG. 7 includes a semiconductor laser 30 mounted on a silicon substrate, four mirrors 31 to 34, and interference light (beat light) pickup mirrors 35 and 36. The semiconductor laser 30 has its both ends provided with an antireflection coating and emits lights respectively from the both ends (refer to Patent document 3). The lights emitted from the both ends of the semiconductor laser 30 are caused by the four mirrors 31 to 34 to travel in respective optical circuits in the right hand direction and the left hand direction, wherein light emitted from the semiconductor laser 30 enters an end thereof opposite to en end from which the light is emitted. The optical circuits function as a ring resonator, and a laser oscillation occurs at the both ends of the semiconductor laser 30. The four mirrors 31 to 34 are fabricated by anisotropic etching of a silicon substrate (silicon micromachining technique), and a metal coating or a dielectric multilayer coating is provided (refer to Japanese Patent Application Laid-Open No. 2003-139539, Paragraph 0037). At least one of the four mirrors 31 to 34 functions as a transmissive mirror adapted to introduce part of the light to the beat light pickup mirrors 35 and 36.

In the semiconductor ring laser gyro described above, when an object rotates about a rotation axis (sensitivity axis) defined by the normal line of the silicon substrate, an optical path difference is generated due to the Sagnac effect between the two paths of the lights traveling respectively in the right hand direction and the left hand directions, and a beat signal based on an oscillation frequency difference is detected. A rotational angular velocity is calculated by a frequency of the beat signal (refer to Japanese Patent Application Laid-Open No. 2006-319104, Paragraph 0015).

The above-described semiconductor ring laser gyro using silicon micromachining technique is advantageous in that a plurality of mirrors can be produced with a high positioning accuracy. The silicon micromachining technique, however, requires semiconductor manufacturing equipment and dedicated clean room equipment, which pushes up production cost. Also, the silicon substrate is thin, has an insufficient strength, therefore cannot be simply used as a gyro body and so must be bonded to a support plate (usually a glass plate). The silicon substrate is bonded to the glass plate by anodic bonding, which requires expensive equipment.

Further, since the reflectance of silicon has a large wavelength dependence, the applicable wavelength of a semiconductor is restricted. And, a mirror may be provided with a reflection coating for the purpose of increasing a reflectance with respect to a certain wavelength, but an advanced coating technique which is disadvantageous in cost and productivity is required for uniformly applying a metal coating or a dielectric multilayer coating to an etching surface rising vertically on the silicon substrate.

A semiconductor ring laser gyro which is structured differently from the semiconductor laser gyro as shown in FIG. 7 and in which reflection surfaces are constituted by a normal mirror can be produced at a low cost, but the optical axis alignment of the mirrors must be conducted. Especially, the angle alignment about an axis orthogonal to the optical circuit plane of the mirrors must be performed so that laser oscillation state is stably produced, for which an additional work is needed. This work requires a critical adjustment and therefore deteriorates productivity thus pushing up production cost.

The laser ring gyro measures a rotational velocity and is used where disturbances such as impact, acceleration, vibration, and the like are applied. Under such a circumstance, it is likely to happen that the optical axes of the reflection mirrors become shifted and misaligned. Especially the angle setup in the optical circuit plane of the mirrors is structured to be adjustable as described above and is easily affected by the disturbances. In this connection, the axis alignment in a plane orthogonal to the optical circuit plane can be assured by component accuracy and therefore does not involve a problem with the aforementioned adjustment and provides a structure resistant to the disturbances.

In the ring laser gyro, since a closed optical circuit functions as a resonator, a semiconductor laser element is disposed in the optical circuit. That is to say, the resonator is not constituted by the semiconductor laser alone but constituted by the entire optical circuit, and the semiconductor laser element is disposed at one portion of the optical circuit. Laser light emitted from the semiconductor laser element travels in the radial direction, not in the collimated direction. So, a resonance in the closed circuit optical (ring resonance) cannot be produced as it is. Therefore, a lens system to beam-form and collimate the laser light emitted from the semiconductor laser is required.

In the semiconductor ring laser gyro, a semiconductor laser element (semiconductor laser chip) having a luminous region with a narrow width is used because of request for a power consumption reduction. Generally, the semiconductor laser element used emits laser light having a luminous region width which is about three times or less as large as the wavelength (for example, the luminous region width is about 3 μm when the wavelength is 1 μm).

When the semiconductor laser element used emits laser light having a luminous region width which is less than about three times of the wavelength, an optical system to achieve collimated light as described above must be a condenser lens with a short focal length and also with a low aberration. However, a lens which, while having a short focal length and at the same time with a low aberration, is capable of appropriately collimating light having a luminous region width less than about three times of the wavelength is expensive thus pushing up the const of an entire device.

In this case, since the lens has a short focal length, a highly precise optical axis alignment is required. In the semiconductor ring laser gyro, laser light emitted from an end of the semiconductor laser element travels in the optical circuit and enters the other end of the semiconductor laser element, whereby laser resonance is caused by a resonator constituted by the entire optical circuit. Therefore, the optical axis alignment of the condenser lens disposed at each of the ends of the semiconductor laser element is important for causing a reliable laser oscillation. However, when the condenser lens used has a short focal length as described above, the optical axis alignment of the condenser lens is delicate thus requiring a troublesome work. As a result, the productivity is deteriorated and production cost is increased. Also, just because the optical axis alignment is delicate, the semiconductor ring laser gyro is susceptible to disturbances.

Also, in the ring laser gyro, the lock-in phenomenon is prevented by a method of dithering of the ring laser gyro relative to the sensitivity axis at a frequency higher than the beat frequency, and also the method of dithering possibly causes the optical axis to be shifted.

If the optical axis is shifted to be misaligned, the resonance condition becomes unstable, and the laser oscillation becomes unstable or even stops. If the laser oscillation becomes unstable, the measurement accuracy is adversely affected, and if the laser oscillation is caused to stop, then the rotational angular velocity cannot be measured.

### SUMMARY OF THE INVENTION

The present invention now has as its object to provide a semiconductor ring laser gyro which is inexpensively produced with a high productivity, and whose measurement accuracy is scarcely affected by disturbances and also is stably assured.

The invention of claim 1 provides a semiconductor ring laser gyro comprising: The invention of claim 1 provides a semiconductor ring laser gyro comprising: a closed optical circuit, the closed optical circuit comprising a plurality of reflection members; a semiconductor laser element disposed in the closed optical circuit and emitting laser light from each end thereof, the semiconductor laser element having a luminous region with a width that is at least ten times as large as a wavelength of the laser light; and a pair of optical systems for forming a shape of the laser light emitted from each end of the semiconductor laser element.

In the invention of claim 1, the luminous region of the semiconductor laser element has a width which is ten times or more as large as the wavelength of light emitted from the luminous region. By arranging the width of the luminous region to be ten times or more as large as the wavelength, the requirement values about the focal length and aberration of the optical systems to form shape of the laser light emitted from the semiconductor laser element are relaxed. Consequently, cost for the optical systems can be reduced. For example, an inexpensive ball lens or resinous lens with a large wavefront aberration can be used as a collimator lens, and cost for lens systems can be reduced.

Also, since the width of light flux traveling in the optical circuit is substantially larger (ten odd times or more) than the wavelength, the accuracy required of the optical axis alignment can be relaxed. Accordingly, the work for adjusting the lenses and the reflection members is eased when assembling the device. And, since the tolerance for the optical axis misalignment is increased, the resultant device is less likely to suffer the influence of disturbances. Especially, since the focal length of the lens used for the optical system does not have to be extremely shortened, the work for the optical axis alignment of the optical system is eased, and also the tolerance for the optical axis misalignment of the optical system caused by disturbances can be substantially secured.

Also, according to the present invention, even when a semiconductor laser element to emit beam with a large width is used, a lower power consumption is achieved compared with when the aforementioned semiconductor laser element is used as a usual semiconductor laser element (for example, for communication purpose). Consequently, the problems such as power consumption increase as the entire device, heat generation from the semiconductor laser element and the power supply, component cost increase due to usage of a large current, and the like can be prevented.

Description will be made on why a lower power consumption can be achieved compared with when the semiconductor is used in a usual manner. In a laser gyro, the entire optical circuit is resonated as a resonator thereby causing laser oscillation. At this time, light picked up from the optical circuit is used only as observation light for measuring the interference of lights traveling in the optical circuit in respective opposite directions. The observation light just has to be capable of measuring the interference of two laser lights and therefore can be minimal. As a result, light loss in the optical circuit including the semiconductor laser element is smaller compared with a usual laser resonator.

On the other hand, in the usual laser resonator, laser oscillation is caused between reflection members, and part of laser light generated is picked up by utilizing half mirror characteristic of one of the reflection members and is used for a predetermined purpose. At this time, the energy of the light picked up out of the resonator constitutes loss for the resonator. Accordingly, the loss for the resonator is inevitably high to some extent.

In the semiconductor laser element used in a manner according to the present invention, since the light picked up from the resonator is just as intense as to enable detection of the beat light generated by the interference, the loss within the resonator can be reduced. Thus, the threshold value of injection current required for causing laser oscillation can be lowered compared with when the semiconductor is used in a usual manner, and the power consumption can be reduced.

In this connection, if the width of the luminous region is less than ten times as large as the wavelength of the laser light emitted from the semiconductor laser element, an optical condenser lens must be constituted by an expensive lens which has a short focal length and a low aberration thus proving unfavorable. Also, the tolerance for the optical axis misalignment is narrowed, and therefore the alignment work is significantly increased and the resistance to disturbances is significantly deteriorated. The width of the luminous region preferably is to range “from 30 to 100 times” as large as the wavelength of the laser light emitted. If the width of the luminous region exceeds the above range, the power consumption of the semiconductor laser element increases and heat generation problem becomes remarkable. Further, if the width of the luminous region exceeds the range, the adjustment workability is not improved, or the resistance to disturbances is not enhanced.

The invention of claim 2 provides a semiconductor ring laser gyro comprising: a closed optical circuit, the closed optical circuit comprising a plurality of reflection members; a semiconductor laser element disposed in the closed optical circuit and emitting laser light from each end thereof, the semiconductor laser element having a luminous region at each end thereof, the luminous region having an aspect ratio of 1 to at least 10; and a pair of optical systems for forming a shape of the laser light emitted from each end of the semiconductor laser element.

In the invention of claim 2, the semiconductor laser element emits laser beams having a wide strip shape (ribbon shape) with a thickness-to-width ratio of 1 to 10 or more. Consequently, the invention of claim 2 can achieve the same advantages as the invention of claim 1. If the aspect of the luminous region has an aspect ratio of 1 to less than 10, the advantages cannot be achieved for the same reason described with respect to the invention of claim 1 thus proving unfavorable. The aspect ratio of the luminous region preferably ranges from “1 to 30” to “1 to 1000”. And, if the aspect ratio exceeds the above range, the power consumption increases and also the advantage coming from increased width cannot be achieved.

The invention of claim 3 is characterized in that the width of the luminous region of the semiconductor laser element as described in the invention of claim 1 or 2 is ten times or more as large as the wavelength of the laser light.

The invention of claim 4 is characterized in that the closed optical circuit in the invention as described in any one of claims 1 to 3 is formed in a plane, and the width direction of the laser light emitted from each of the both ends of the semiconductor laser element is oriented parallel to the plane.

In the invention of claim 4, the accuracy for the optical axis alignment in the optical circuit plane, which involves problems with optical axis alignment and misalignment, is relaxed. That is to say, if the width direction of the luminous region is aligned with the optical circuit plane, then the work for the optical axis alignment in the optical circuit plane can be performed with a relaxed accuracy. As a result, the work for optical axis alignment in the optical circuit plane is eased. Also, the tolerance for the optical misalignment in the optical circuit plane due to disturbances can be substantially secured, which is favorable for a stable laser oscillation. Thus, the resultant semiconductor ring laser gyro is hardly susceptible to the disturbances.

The invention of claim 5 is characterized in that the optical system in the invention as described in any one of claims 1 to 4 is constituted by either a resinous lens or a ball lens.

In the invention of any one of claims 1 to 4, the condenser lens (generally called “collimator lens”) to put into a parallel light the laser light emitted from the semiconductor laser element is allowed to have some aberration. The reason is that since the condenser lens used can have a long focal length, the effect of the aberration on the optical function to achieve and collimate the parallel light and to collimate is relatively small. For this reason, the optical system which does not adversely affect the ring resonance can be structured even if a resinous lens or a ball lens is used which is inexpensive but unfavorable in terms of aberration. Thus, cost for the lens system can be reduced,

According to the present invention, a semiconductor ring laser gyro is provided which is inexpensively produced with a high productivity, and whose measurement accuracy is scarcely affected by disturbances and also is stably assured.

### BRIEF DESCRIPTION OF THE DRAWINGS

FIG. 1 is a perspective view of a semiconductor ring laser gyro according to an embodiment of the present invention;

FIG. 2 is a top plan view of a semiconductor ring laser gyro of the embodiment;

FIG. 3(A) is a perspective schematic view of a semiconductor laser that can be applied for the present invention, and FIG. 3(B) is a schematic view of a luminous region;

FIG. 4 is a schematic view of explaining optical characteristics of a condenser lens;

FIG. 5 is a schematic view of showing view of showing a relation between injection current value and light output of a semiconductor laser element;

FIG. 6 is a top plan view of a semiconductor ring laser gyro according to another embodiment of the present invention; and

FIG. 7 is a top plan view of a conventional semiconductor ring laser gyro.

### DETAILED DESCRIPTION OF THE INVENTION

Examples of semiconductor ring laser gyros according to the present invention will hereinafter be described.

### (1) First Embodiment

### Structure of the First Embodiment

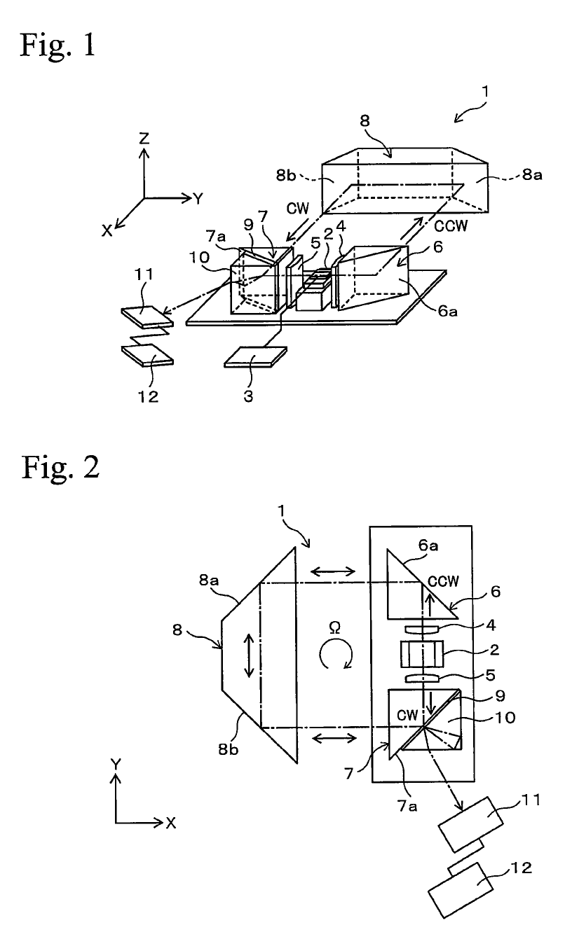

FIG. 1 is a perspective view of a semiconductor ring laser gyro 1 according to the first embodiment, and FIG. 2 is a top plan view of FIG. 1. Referring to FIG. 1, the semiconductor ring laser gyro 1 includes a semiconductor laser element 2, a driving power supply 3, two collimator lenses 4 and 5, two rectangular prisms 6 and 7, a trapezoidal prism 8, a transmissive mirror 9, a beam multiplexing prism 10, a light receiving portion 10, and a signal processing portion 12.

The semiconductor laser element 2 may be an oscillation element developed for solid laser excitation with an oscillation wavelength of 800 nm band (near infrared), or an oscillation element developed for optical communication with an oscillation wavelength of 14800 nm band (infrared light). The semiconductor laser element 2 is made of, for example, AlGaAs or GaAs material to emit light with a wavelength of a visible light or an infrared light. The semiconductor laser element 2 is composed of a normal double heterostructure including an n type cladding layer/an active layer/a p type cladding layer, electrodes, and the like, wherein an antireflection coating is applied to each of both end faces of the active layer.

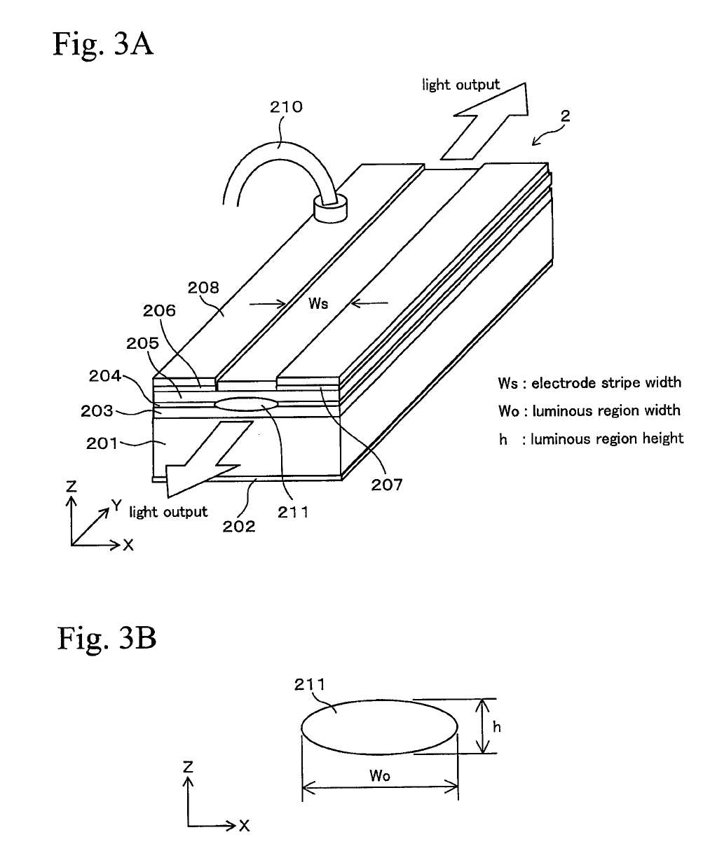

FIG. 3 (A) is a schematic view of an example for the semiconductor laser element 2. The semiconductor laser element 2 shown in FIG. 3 (A) is made of an n-type GaAs substrate 201. A negative electrode 202 is disposed on the lower surface of the GaAs substrate 201. The negative electrode 202 is made of a suitable metal film. An n⁺-type cladding layer 203 which is a stronger n-type cladding layer than the GaAs substrate 201 is disposed on the upper surface of the GaAs substrate 201, an active layer 204 with an i- or n⁻-type conductivity is disposed on the cladding layer 203, and further a p-type cladding layer 205 is disposed on the active layer 204. The aforementioned layers are made by a method of doping impurities or a method of film formation to thereby provide one productivity type.

Insulation layers 206 and 207 made of, for example, an oxide film are disposed on the cladding layer 205 with a distance Ws therebetween. A positive electrode 208 is disposed on the insulation layers 206 and 207 disposed over the active layer 204. The positive electrode 208 is made of a suitable metal film. And, a wire 210 is connected to the positive electrode 208.

When a voltage is applied between the positive electrode 208 and the negative electrode 202, electrons and holes are injected into the active layer 204 and are recoupled to each other. At this time, stimulated emission of photons occurs, and light is outputted from a luminous region 211 in both positive and negative directions along a Y axis in the figure. The light outputted travels in a closed optical circuit (to be described hereinafter) and enters the other output end, wherein certain resonance conditions are met, and laser oscillation is caused.

For reference sake, normally, the length of a semiconductor laser element in the direction along the Y axis (the length is called “resonator length”) is set to an optical length which is produced by the resonance caused at the emission wavelength, a reflection surface to inwardly direct light is formed at an end face of the active layer 204, and a reflection surface to inwardly direct light while having predetermined transmission characteristics is formed at the other end face of the active layer 204. The light emitted is caused to shuttle between the both reflection surfaces, and resonance state is produced, whereby the aforementioned stimulated emission is caused to continuously occur in the active layer 204, and the amount of light emitted increases in an avalanche manner. This causes laser oscillation.

FIG. 3 (B) is a schematic view of the luminous region 211. Referring to FIG. 3 (B), the luminous region 211 has a width Wo (dimension in the direction along the active layer 204) substantially equal to the distance Ws and has a height h slightly larger than the thickness of the active layer 204. In the example, the width Wo is 50 μm and the height h is 1 μm. That is to say, the luminous region has a aspect ratio of 1 to 50. Also, the direction of the width Wo is aligned to the direction along an optical circuit plane (X-Y plane shown i FIGS. 1 to 3 (A)).

An antireflection coating (not shown) is formed at the end face of the luminous region 211. The antireflection coating is formed of a metal film or a dielectric multilayer film determined in consideration of the refractive index and the chemistry of the active layer 204 of the semiconductor laser element 2, and the reflectance of the antireflection coating is substantially 0% at the central oscillation wavelength.

A semiconductor laser element having a wide luminous region may be structured so as to suppress light from spreading in the connection direction to thereby lower operating current. Specifically, a semiconductor laser element used may be provided with a structure of a planar stripe type, a mesa stripe type, a side connection type, a hetero isolation stripe type, a buried hetero stripe type, native oxide stripe type, and the like.

Referring back to FIG. 1, the driving power supply 3 is connected to the electrodes of the semiconductor laser element 2. The collimator lenses 4 and 5 function as a light condensing lens and are a plano-convex lens made of transparent plastic resin (for example, thermoplastic resin, acrylic resin, polycarbonate resin, polyolefin resin, and the like). The collimator lenses 4 and 5 are disposed respectively at the both ends of the semiconductor laser element 2 so as to be aligned on the light emission axis of the semiconductor laser element 2. One light of the lights emitted respectively from the semiconductor laser element 2 in two opposite directions is collimated by the collimator lens 4 to become parallel light and enters the rectangular prism 6. The other light emitted is collimated by the collimator lens 5 to become parallel light and enters the rectangular prism 7. In this connection, the collimator lens 4 and 5 may be discrete from the rectangular prisms 6 and 7 and joined thereto, or may alternatively be integrated with the rectangular prisms 6 and 7 such that the light entrance faces of the rectangular prisms 6 and 7 are shaped aspheric. In such a structure, a mounting mechanism for the collimator lenses 4 and 5 is not required, which results in reducing influences attributable to the disturbances such as dithering for prevention of the lock-in phenomenon.

The rectangular prisms 6 and 7 function as a reflection member to constitute the optical circuit and are disposed to be aligned on the light emission axis of the semiconductor laser element 2. Reflection surfaces 6a of the rectangular prism 6 and reflection surfaces 7a of the reflection prism 7 are inclined at 45 degrees relative to the light emission axis of the semiconductor laser element 2 as shown in FIG. 2. The reflection surface 6a of the rectangular prism 6 and the reflection surface 7a of the rectangular prism 7 are disposed symmetric to each other with respect to the semiconductor laser element 2. The rectangular prism 6 receives the parallel light from the collimator lens 4, and the light received is internally reflected at 45 degrees at the reflection surface 6a and exits from the rectangular prism 6. The rectangular prism 7 receives the parallel light from the collimator lens 5, and the light received is internally reflected at 45 degrees at the reflection surface 7a and exits from the rectangular prism 7. The lights having exited the rectangular prisms 6 and 7 enter the trapezoidal prism 8. In this connection, if the refractive index of air is 1, the rectangular prisms 6 and 7 have a refractive index n of about 1.4 or more given from the Snell's law according to formula 1 shown below:

n≧1/sin θ Formula 1

The trapezoidal prism 8 functions as a reflection member to constitute the optical circuit and is disposed to oppose the two rectangular prisms 6 and 7. Two reflection surfaces 8a and 8b of the trapezoidal prism 8 are inclined at 45 degrees relative to the light emission axes of the rectangular prisms 6 and 7 and are disposed symmetric to each other. The trapezoidal prism 8 receives the lights from the rectangular prisms 6 and 7, and the lights received are internally reflected twice at 45 degrees respectively at the reflection surfaces 8a and 8b and exit from the trapezoidal prism 8. The trapezoidal prism 8 also has a refractive index n of about 1.4 or more according to formula 1 shown above.

The optical circuit of the semiconductor ring laser gyro 1 has a closed quadrangular optical path structure constituted by using internal reflections at the two rectangular prisms 6 and 7 and the trapezoidal prism 8 as described above. According to the optical path structure, light emitted from the semiconductor laser 2 in the positive Y axis direction travels via the collimator lens 4, the rectangular prism 6, the trapezoidal prism 8, the rectangular prism 7 and the collimator lens 5, and returns to the semiconductor laser 2. And, light emitted from the semiconductor 2 in the negative Y axis direction travels via the collimator lens 5, the rectangular prism 7, the trapezoidal prism 8, the rectangular prism 6 and the collimator lens 4, and returns to the semiconductor laser 2. By the lights traveling in the optical circuits, continuous stimulated emission of electrons is induced, whereby laser oscillation occurs based on the entire optical path functioning as a resonator (that is ring resonator).

The transmissive mirror 9 is a partially-transmissive film or a semi-transmissive film (half mirror) which is made of a dielectric multilayer film including a high-refractive film H (for example TiO₂) and a low refractive film L (for example SiO₂) deposited alternately on each other, or made of a metal film (Al, Au, Ag and the like). The transmissive mirror 9 is formed at the reflection surface of one of the rectangular prism 6, the rectangular prism 7 and the trapezoidal prism 8 of the optical circuit. In the example, the transmissive mirror 9 is formed at the reflection surface 7a of the rectangular prism 7 as shown FIGS. 1 and 2.

In the above laser oscillation state, CW light traveling in the optical circuit in the right hand direction and CCW light traveling in the optical circuit in the left hand direction transmit partly through the reflection surface 7a. The transmissive mirror 9 has such a transmittance as to enable the beat lights of the CW and CCW lights to be detected at the light receiving portion 11 to be detailed later. The two lights having transmitted therethrough enter the beam multiplexing prism 10.

The beam multiplexing prism 10 is joined via the transmissive mirror 9 to the reflection surface of one of the rectangular prism 6, the rectangular prism 7 and the trapezoidal prism 8. In the example, the beam multiplexing prism 10 is joined to the reflection surface 7a of the rectangular 7 on which the transmissive mirror 9 is formed. The beam multiplexing prism 10 receives the CW and CCW lights, and the CW and CCW lights received are internally reflected in the beam multiplexing prism 10, wherein the beam multiplexing prism 10 functions to align the emission axes of the CW and CW lights to each other. According to the function, a composite waveform of the CW and CCW lights, namely, an interference light (beat light) is picked up. The beat light of the CW and CCW lights enters the light receiving portion 11.

The light receiving portion 11 is disposed on the axis of the light emitted from the beam multiplexing prism 10 and is constituted by a photodiode, a phototransistor, or a photo IC. The light receiving portion 11 receives the beat light emitted from the beam multiplexing prism 10 and converts the amount of the light into a current value. The current is appropriately amplified by an operation amplifier and converted into a voltage by a variable resistor or the like. The value of the voltage is compared with a reference voltage by a comparator (not shown) and converted into a pulse signal (beat signal) of 0 or 1.

The signal processing portion 12 is a microcomputer which includes a ROM to store programs and data, a CPU to perform arithmetic processing based on the program stored in the ROM, a RAM to temporarily store the program and data run by the CPU, a counter to measure the clock number of pulse signal, and a clock oscillator. The signal processing portion 12 receives the beat signal from the light receiving portion 11, and the clock number of the beat signal (beat frequency) is measured by the counter. The signal processing portion 12 calculates an angular velocity Ω from the beat frequency Δf measured according to formula 2 to be presented later. In formula 2, A is an area enclosed by the optical circuit of the ring resonator, L is a length of the optical circuit, and λ is an oscillation wavelength of the ring resonator. Thus, the semiconductor ring laser gyro 1 is adapted to detect the rotational angular velocity of an object based on the Sagnac effect (an optical path difference between the CW light and the CCW light) generated when the object rotates.

Formula 2 below is a principle formula, and actually the parameters A and L are values determined in consideration of influences of the refractive index of the member disposed in the optical path or values to reflect the influences. Such correction is made by using a correction value and a correction function which are obtained analytically or experimentally and stored in the ROM of the signal processing portion 12.

$$Δ f = \frac{4 A}{λ L} Ω \qquad Formula 2$$

### Operation of the First Embodiment

When a voltage from the driving power supply 3 shown in FIG. 1 is applied between the positive and negative electrodes 208 and 202 of the semiconductor laser element 2 shown in FIG. 3 (A), photons are emitted from the active layer 203 of the semiconductor laser element 2 by stimulated emission. Light emitted by stimulated emission is outputted from each of the luminous regions (one thereof is shown by reference numeral 211) located at the both end faces of the active layer 3. Light emitted from one end of the semiconductor laser element 2 travels in the optical circuit and enters the other end face of the active layer thereby newly emitting photons by stimulated emission. This phenomenon occurs continuously in the both optical circuit directions, whereby laser oscillation is caused by light emitted by the semiconductor laser element 2 working as excitation source.

In this laser oscillation state, the CW light and CCW light are synthesized by the beam multiplexing prism 10, emitted therefrom and enter the light receiving portion 11. When the semiconductor ring laser gyro 1 rotates with an angular velocity Q in the direction as shown in FIG. 2 (or in the opposite direction), a frequency difference is generated between the CW and CCW lights due to the Sagnac effect and is outputted as beat signal from the light receiving portion 11. A calculation is performed at the signal processing 12 according to the beat signal, and the angular velocity Ω is detected. Also, information about the rotation direction can be obtained if the direction of beat frequency change is measured.

### Advantages of the First Embodiment

Description will be made of the advantages of the first embodiment. In the example, the width Wo of the luminous region 211 shown in FIG. 3 (B) is 50 μm, and the luminous region 211 has a large aspect ratio thus having a wide beam configuration. Accordingly, the focal length of the collimator lenses 4 and 5 to achieve parallel light does not have to be extremely short and also the requirements about aberration are relaxed.

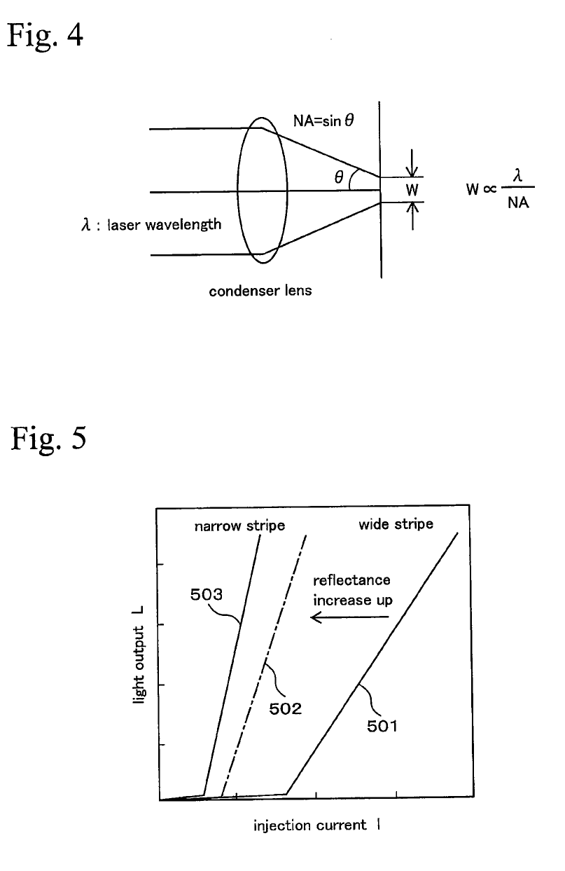

FIG. 4 is a schematic view of explaining the optical characteristics of a condenser lens. An NA value is one parameter of the optical characteristics of a condenser lens. The larger the NA value is, the shorter the focal length of the condenser lens has to be, which is unfavorable in terms of aberration. Specifically, if the NA value of a lens decreases, the aberration tends to increase, and therefore it is difficult to increase the NA value while the aberration is kept at a low level. This tendency becomes notable especially when a dimension W is equal to or less than several wavelengths. It is not impossible to produce a lens which has a large NA value with aberration kept to a low level, but the cost becomes high.

In the present embodiment, when optically designing the collimator lenses 4 and 5, the beam width W of condensed light can be set equal to the width Wo of the luminous region 211 of FIG. 3 (B). Consequently, the NA value can be set smaller compared with a conventional case where the width Wo is small thus proving favorable in terms of aberration, and a lens which is available at a low cost can be used. For example, a resinous lens, which is produced by molding method and unfavorable in terms of aberration, can be appropriately used. As a result, the cost of a gyro device can be held down.

In this connection, since a condenser lens with a low NA value can be used, the work of aligning the optical axis for the collimator lenses 4 and 5 as a condenser lens in the X-Y plane can be eased. Thus, the production cost can be reduced. Also, the tolerance for the optical axis misalignment of the collimator lenses 4 and 5 due to disturbances can be increased. This enables the gyro device to be less likely to undergo the influence of the disturbances.

Further, even when the semiconductor laser element 2 having a wide luminous region as shown in FIG. 3 (B) is used, the power consumption is lowered compared to when a similar semiconductor laser element is used in a usual manner. That is to say, in the present embodiment, while laser oscillation is caused in a closed optical path, the light picked up from the optical path only has to have intensity high enough to measure the interference. As a result, the loss for the laser resonator can be kept at a low level, and laser oscillation can be caused by a relatively low injection current. Therefore, when a semiconductor laser element having a wide luminous region is used, the power consumption can be suppressed compared to when a semiconductor laser element having a narrow luminous region.

On the other hand, in the case of the semiconductor laser element that is used in a usual manner, a reflection mirror is disposed at the luminous region at one end of the semiconductor laser element, a half reflection mirror is disposed at the luminous region at the other end, and laser resonance is produced between the both reflection mirrors, and at the same time light is picked up from the half reflection mirror and is consumed for communication and for writing and reading information. Thus, if the output of laser light consumed increases, loss for the laser resonator increases by that much, and a relatively large injection current is required for laser oscillation.

FIG. 5 is a schematic view showing a relation between the injection current value and the light output of a semiconductor laser element. In FIG. 5, the horizontal axis indicates a value I (relative value) of the injection current, and the vertical axis indicates a light output L. The output L refers to the amount of light in the resonator.

Characteristic 501 is obtained when a semiconductor laser element to emit light with a wide stripe as shown in FIG. 3 is used in a usual manner. Characteristic 502 is obtained when the aforementioned same semiconductor element is used in the composition structure according to the present embodiment. Comparison between the both characteristics shows that while the semiconductor laser element with the same basic structure is used, a slight amount of light is picked up out of the resonator in the present embodiment, and therefore the injection current required for laser oscillation is relatively suppressed. Characteristic 503 is obtained when a semiconductor laser element has a luminous region with an aspect ration of 1 to 3. In this case, laser oscillation can be caused by a still lower injection current.

### (2) Second Embodiment

A ball lens is used as an optical system to condense laser light emitted from each of a semiconductor laser element. The ball lens is inexpensive and component cost can be reduced. Also, since the NA vale described with reference to FIG. 4 can be reduced, the optical axis alignment does not have to be performed with a strict accuracy, and the tolerance for the optical alignment misalignment due to disturbances can be increased.

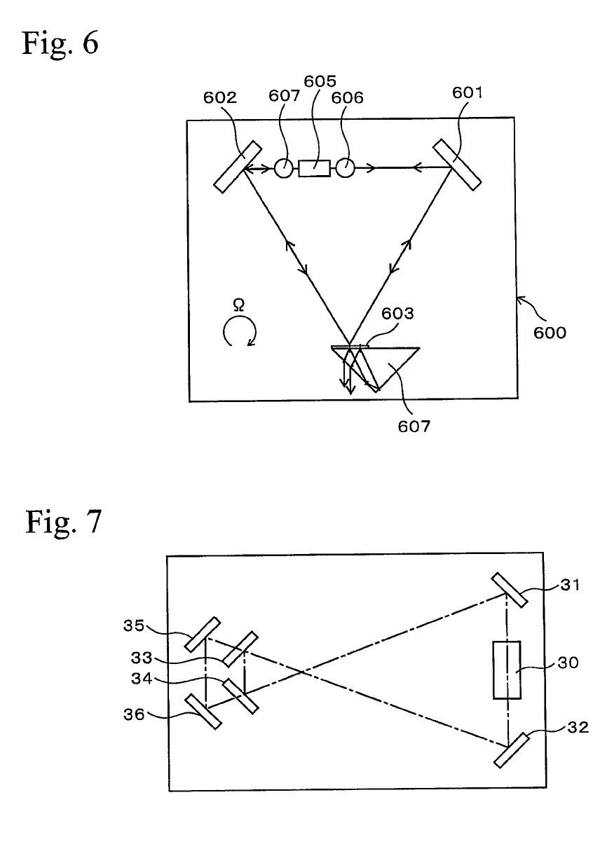

Description will be made on an example of semiconductor ring laser gyro according to the second embodiment which includes a ball lens and also reflection members that are different from those used in the first embodiment. FIG. 6 is a schematic view of a semiconductor ring laser gyro 600 according to the second embodiment. Referring to FIG. 6, the semiconductor laser gyro 600 includes reflection mirrors 601 and 602 and a transmissive mirror 603. The reflection mirrors 601 and 602 are a normal mirror having a metal film formed on its surface. The transmissive mirror 603 has the same structure as the transmissive mirror 9 of FIGS. 1 and 2 and is adapted to transmit light to the extent that the transmitted light enables a light receiving portion (not shown) to detect interference light.

A closed triangular optical path (optical circuit) is constituted by the reflection mirrors 601 and 602 and the transmissive mirror 603. A semiconductor laser element 605 is disposed on the optical circuit, and ball lenses 606 and 606 are provided respectively at both light emitting ends of the semiconductor laser element 605. The ball lenses 606 and 607 function as a condenser lens. The semiconductor laser element 605 is the same as the semiconductor laser element 2 of FIG. 3 (A).

A beam multiplexing prism 607 is joined to the transmissive mirror 603. The beam multiplexing prism 607 synthesizes CW laser light and CCW light which travel in the optical circuit. If there is a difference in frequency between the both laser lights, beat light, that is interference light, is outputted from the beam multiplexing prism 607. A light receiving portion and a signal processing portion (both not shown) structured the same as those shown in FIG. 1 are disposed at the output side of the beam multiplexing prism 607.

The semiconductor laser element 605 emits light from each of the both ends thereof. At this time, the optical circuit constituted by the reflection mirrors 601 and 602 and the transmissive mirror 603 functions as a laser resonator, and laser oscillation is caused. And, when a rotation is caused in a direction indicated by a angular velocity Ω shown in the figure (or in the opposite direction), interference light is outputted from the beam multiplexing prism 607 due to the Sagnac effect, and the angular velocity Ω and the rotation direction are detected according to the output. Also, information about the rotation direction can be obtained if the direction of beat frequency change is measured.

Since ball lenses are used in the semiconductor ring laser gyro 600 of FIG. 6, component cost can be reduced. Also, since the ball lens has a low NA value, the optical axis alignment is not difficult thus reducing cost for the alignment work. Further, since the tolerance for the optical axis misalignment can be increased, the resultant gyro is resistant to disturbances. The advantage in terms of optical axis misalignment applies to the reflection mirrors 601 and 602.

The present invention can be applied for attitude control of aircraft, rocket, artificial satellite, submarine, robot, automobile, and the like, and for use as a semiconductor ring laser gyro for autonomous navigation.

What is claimed is:

1. A semiconductor ring laser gyro comprising:
a closed optical circuit, the closed optical circuit comprising a plurality of reflection members;
a semiconductor laser element disposed in the closed optical circuit and emitting laser light from each end thereof, the semiconductor laser element having a luminous region with a width that is at least ten times as large as a wavelength of the laser light; and
a pair of optical systems for forming a shape of the laser light emitted from each end of the semiconductor laser element.

2. A semiconductor ring laser gyro comprising:
a closed optical circuit, the closed optical circuit comprising a plurality of reflection members;
a semiconductor laser element disposed in the closed optical circuit and emitting laser light from each end thereof, the semiconductor laser element having a luminous region at each end thereof, the luminous region having an aspect ratio of 1 to at least 10; and
a pair of optical systems for forming a shape of the laser light emitted from each end of the semiconductor laser element.

3. A semiconductor ring laser gyro according to claim 2, wherein a width of the luminous region of the semiconductor laser element is at least ten times as large as a wavelength of the laser light.

4. A semiconductor ring laser gyro according to claim 1, wherein the closed optical circuit is formed in a plane, and a width direction of the laser light emitted from each end of the semiconductor laser element is oriented parallel to the plane.

5. A semiconductor ring laser gyro according to claim 1, wherein the optical system comprises at least one of a resin lens and a ball lens.
